(19) United States
(12) Patent Application Publication
(10) Pub. No.: US 2021/0210102 A1
(43) Pub. Date: Jul. 8, 2021

(54) DATA PROCESSING METHOD BASED ON ARTIFICIAL INTELLIGENCE

(71) Applicant: LG ELECTRONICS INC., Seoul (KR)

(72) Inventors: Jiyoung HUH, Seoul (KR); Jinsung PARK, Seoul (KR); Moonsub JIN, Seoul (KR); Jihye KIM, Seoul (KR); Jungsu LEE, Seoul (KR)

(73) Assignee: LG ELECTRONICS INC., Seoul (KR)

(21) Appl. No.: 17/011,633

(22) Filed: Sep. 3, 2020

(30) Foreign Application Priority Data
Jan. 7, 2020 (KR) 10-2020-0002186

(51) Int. Cl. G10L 17/18; G10L 17/04; G10L 17/14; G06T 19/00; H04W 72/04

(52) U.S. Cl. CPC G10L 17/18; G10L 17/04; H04W 72/0413; G06T 19/006; G10L 17/14

(57) ABSTRACT

Provided is a data processing method. The data processing method based on artificial intelligence includes cooperating between an agent of a first speaker and an agent of a second speaker, while sharing information, and executing an application in a first smart device or a second smart device according to a result of the cooperation. The data processing method may be associated with an artificial intelligence module, a drone (unmanned aerial vehicle (UAV)), a robot, an augmented reality (AR) device, a virtual reality (VR) device, and a device related to a 5G service.

### BACKGROUND OF THE INVENTION

### Field of the invention

The present disclosure relates to a data processing method based on artificial intelligence.

### Related Art

Machine learning is an algorithm technology that classifies/learns features of input data by itself, and elementary technology is a technology that simulates functions such as cognition and judgment of the human brain using machine learning algorithms such as deep learning and includes technical fields such as linguistic understanding, visual understanding, reasoning/prediction, knowledge expression, motion control, and the like.

Meanwhile, in data processing, it is necessary for agents in a cloud to share information in mobile devices of a cloud environment.

### SUMMARY OF THE INVENTION

The present disclosure also provides a data processing method based on artificial intelligence in which agents in a cloud cooperate with each other in a mobile device of a cloud environment, while sharing information between multiple agents, according to a permission of a user.

In an aspect, a data processing method based on artificial intelligence includes: accessing an agent of first speaker in a cloud; collecting conversation, while listening to a conversation between the first speaker and a second speaker using a first smart device connected to the agent of the first speaker; accessing an agent of the second speaker in the cloud through the agent of the first speaker; determining, if a preset wake-up word in the conversation is sensed, whether an application is executed in the first smart device based on the wake-up word; cooperating between the connected agent of the first speaker and the connected agent of the second speaker, while sharing information, if the application is not executed; and executing the application in the first smart device according to a result of the cooperation.

In the accessing to the agent of the first speaker in the cloud, the first smart device and the agent of the first speaker may be connected to each other if the first speaker logs in through the first smart device.

The accessing to the agent of the second speaker may include: determining the second speaker based on a voice of the second speaker in the conversation; and connecting the agent of the first speaker to the agent of the second speaker if the second speaker is determined.

The determining of the second speaker may include: extracting feature values from sensing information acquired through the voice of the second speaker; and inputting the feature values to an artificial neural network (ANN) trained to distinguish the second speaker through the feature values and determining the second speaker from an output of the ANN, wherein the feature values are values for distinguishing the second speaker.

The voice of the second speaker may include: speaker identification, acoustic event detection, gender and age detection, voice activity detection, and emotion classification.

The agent of the second speaker may determine normal connection upon receiving information on the second speaker from the agent of the first speaker.

The agent of the second speaker may transmit information on the normal connection to a second smart device connected to the agent of the second speaker.

The data processing method may further include: receiving downlink control information (DCI) used for scheduling transmission of the voice of the second speaker, wherein the voice of the second speaker is transmitted to the network based on the DCI.

The data processing method may further include: performing an initial access procedure with the network based on a synchronization signal block (SSB), wherein the voice of the second speaker is transmitted to the network via a physical uplink shared channel (PUSCH) and the SSB and a demodulation reference signal (DM-RS) of the PUSCH are quasi-co-located (QCL) for a QCL type D.

The data processing method may further include: controlling a transceiver to transmit the voice of the second speaker to an AI processor included in the network; and controlling the transceiver to receive AI-processed information from the AI processor, wherein the AI-processed information is information for determining the second speaker.

### BRIEF DESCRIPTION OF THE DRAWINGS

FIG. 1 is a block diagram of a wireless communication system to which the methods proposed in the present disclosure may be applied.

FIG. 2 shows an example of a signal transmitting/receiving method in a wireless communication system.

FIG. 3 shows an example of a basic operation of a user terminal and a 5G network in a 5G communication system.

FIG. 4 is a block diagram showing an electronic device.

FIG. 5 is a schematic block diagram of an AI server according to an embodiment of the present disclosure.

FIG. 6 is a schematic block diagram of an AI device according to another embodiment of the present disclosure.

FIG. 7 is a conceptual diagram illustrating an embodiment of an AI device.

FIG. 8 is an exemplary block diagram of a data processing device according to an embodiment of the present disclosure.

FIG. 9 is an exemplary block diagram of a data processing device according to another embodiment of the present disclosure.

FIG. 10 is an exemplary block diagram of an intelligent agent according to an embodiment of the present disclosure.

FIG. 11 is a diagram illustrating a relationship between a smart device and an agent according to an embodiment of the present disclosure.

FIG. 12 is a diagram illustrating a data processing method based on artificial intelligence according to an embodiment of the present disclosure.

FIG. 13 is a diagram illustrating a process in which a first smart device and an agent of a first speaker are connected according to an embodiment of the present disclosure.

FIG. 14 is a diagram illustrating a process of connecting to an agent of a second speaker using an agent of a first speaker according to an embodiment of the present disclosure.

FIG. 15 is a diagram illustrating an example of determining a second speaker according to an embodiment of the present disclosure.

FIG. 16 is a diagram illustrating another example of determining a second speaker according to an embodiment of the present disclosure.

FIG. 17 is a diagram illustrating a data processing method based on artificial intelligence according to another embodiment of the present disclosure.

FIG. 18 is a diagram illustrating an example of a data processing method based on artificial intelligence according to an embodiment of the present disclosure.

FIG. 19 is a diagram illustrating another example of a data processing method based on artificial intelligence according to an embodiment of the present disclosure.

FIG. 20 is a diagram illustrating another example of a data processing method based on artificial intelligence according to an embodiment of the present disclosure.

FIG. 21 is a diagram illustrating an example of accessing an agent using a smart device according to an embodiment of the present disclosure.

FIG. 22 is a diagram illustrating another example of accessing an agent using a smart device according to an embodiment of the present disclosure.

### DESCRIPTION OF EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

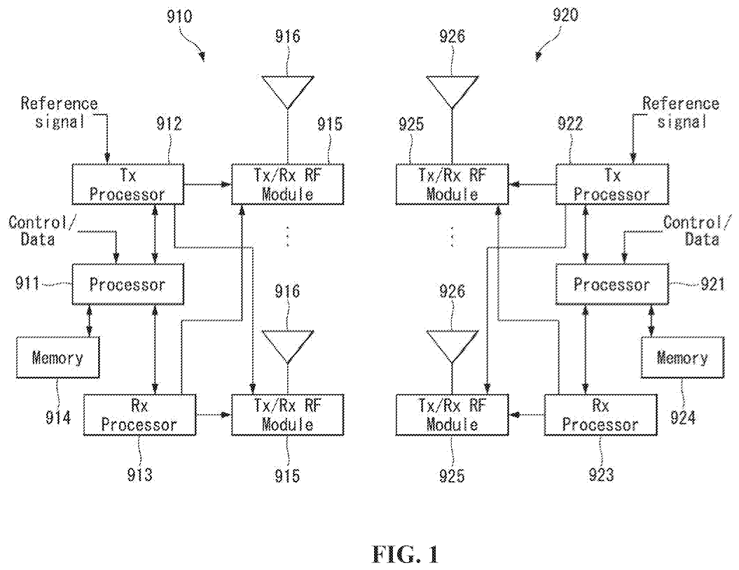

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

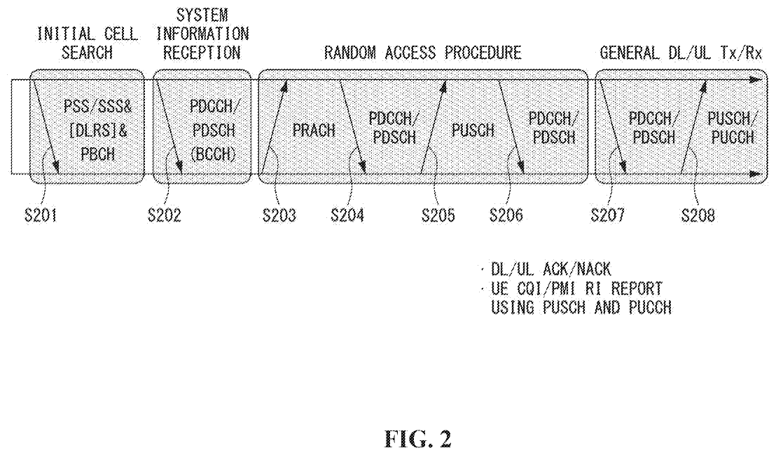

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

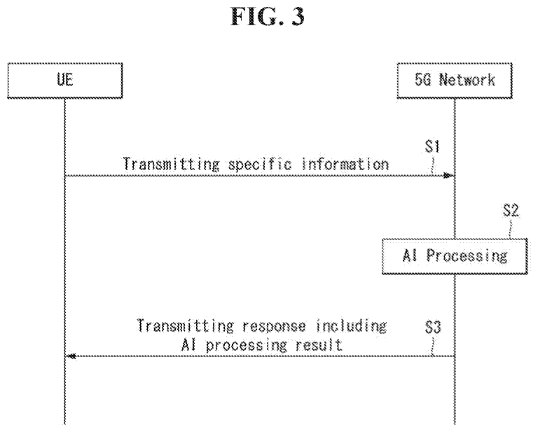

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

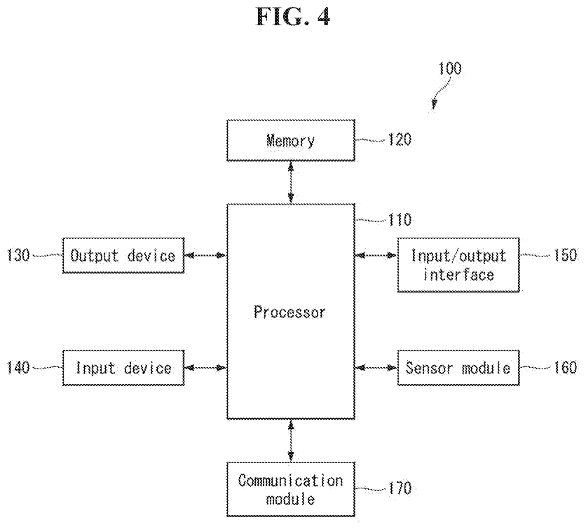

FIG. 4 is a block diagram of an electronic device.

Referring to FIG. 4, the electronic device 100 may include at least one processor 110, a memory 120, an output device 130, an input device 140, an input/output interface 150, a sensor module 160, and a communication module 170.

The processor 110 may include at least one application processor (AP), at least one communication processor (CP), or at least one artificial intelligence (AI) processor. The application processor, the communication processor, or the AI processor may be included in different integrated circuit (IC) packages, respectively, or may be included in one IC package.

The application processor may control a plurality of hardware or software components connected to the application processor by driving an operating system or an application program, and perform various data processing/operation including multimedia. As an example, the application processor may be implemented as a system on chip (SoC). The processor 110 may further include a graphic processing unit (GPU) (not shown).

The communication processor may perform functions of managing a data link and converting a communication protocol in communication between the electronic device 100 and other electronic devices connected through a network. As an example, the communication processor may be implemented as the SoC. The communication processor may perform at least some of a multimedia control function.

In addition, the communication processor may control data transmission and reception of the communication module 170. The communication processor may be implemented to be included as at least a part of the application processor.

The application processor or the communication processor may load and process a command or data received from at least one of a non-volatile memory or other components connected to each into a volatile memory. In addition, the application processor or the communication processor may store data received from at least one of other components or generated by at least one of the other components in the non-volatile memory.

The memory 120 may include an internal memory or an external memory. The internal memory may include at least one of a volatile memory (e.g. dynamic RAM (DRAM)), static RAM (SRAM), synchronous dynamic RAM (SDRAM)) or a non-volatile memory (e.g. one time programmable ROM (OTPROM)), programmable ROM (PROM), erasable and programmable ROM (EPROM), electrically erasable and programmable ROM (EEPROM), mask ROM, flash ROM, NAND flash memory, NOR flash memory, etc.). According to an embodiment, the internal memory may take the form of a solid state drive (SSD). The external memory may further include flash drive, for example, compact flash (CF), secure digital (SD), micro secure digital (Micro-SD), mini secure digital (Mini-SD), extreme digital (xD) or a memory stick, etc.

The output device 130 may include at least one of a display module or a speaker. The output device 130 may display various data including multimedia data, text data, voice data, or the like to a user or output the sound.

The input device 140 may include a touch panel, a digital pen sensor, a key, or an ultrasonic input device, etc. As an example, the input device 140 may be the input/output interface 150. The touch panel may recognize a touch input in at least one of capacitive, pressure-sensitive, infrared, or ultrasonic types. In addition, the touch panel may further include a controller (not shown). In the case of the capacitive type, not only direct touch but also proximity recognition is possible. The touch panel may further include a tactile layer. In this case, the touch panel may provide a tactile reaction to the user.

The digital pen sensor may be implemented using the same or similar method to receiving a user's touch input or a separate recognition layer. The key may be a keypad or a touch key. The ultrasonic input device is a device that can confirm data by detecting a micro-sonic wave at a terminal through a pen generating an ultrasonic signal, and is capable of wireless recognition. The electronic device 100 may also receive a user input from an external device (for example, a network, computer, or server) connected thereto using the communication module 170.

The input device 140 may further include a camera module and a microphone. The camera module is a device capable of photographing images and videos, and may include one or more image sensors, an image signal processor (ISP), or a flash LED. The microphone may receive a voice signal and convert it into an electrical signal.

The input/output interface 150 may transmit commands or data input from the user through the input device or the output device to the processor 110, the memory 120, the communication module 170, and the like through a bus (not shown). For example, the input/output interface 150 may provide data for a user's touch input input through the touch panel to the processor 110. For example, the input/output interface 150 may output a command or data received from the processor 110, the memory 120, the communication module 170, etc. through the bus through the output device 130. For example, the input/output interface 150 may output voice data processed through the processor 110 to the user through the speaker.

The sensor module 160 may include at least one of a gesture sensor, a gyro sensor, a barometric pressure sensor, a magnetic sensor, an acceleration sensor, a grip sensor, a proximity sensor, an RGB (red, green, blue) sensor, a biometric sensor, a temperature/humidity sensor, an illuminance sensor or an ultra violet (UV) sensor. The sensor module 160 may measure physical quantities or sense an operating state of the electronic device 100 to convert the measured or sensed information into electrical signals. Additionally or alternatively, the sensor module 160 may include an E-nose sensor, an electromyography (EMG) sensor, an electroencephalogram (EEG) sensor (not shown), an electrocardiogram (ECG) sensor, a photoplethysmography (PPG) sensor, a heart rate monitor (HRM) sensor, a perspiration sensor, a fingerprint sensor, or the like. The sensor module 160 may further include a control circuit for controlling at least one sensor included therein.

The communication module 170 may include a wireless communication module or an RF module. The wireless communication module may include, for example, Wi-Fi, BT, GPS or NFC. For example, the wireless communication module may provide a wireless communication function using a radio frequency. Additionally or alternatively, the wireless communication module may include a network interface, modem, or the like for connecting the electronic device 100 to a network (e.g. Internet, LAN, WAN, telecommunication network, cellular network, satellite network, POTS or 5G network, etc.).

The RF module may be responsible for transmitting and receiving data, for example, transmitting and receiving an RF signal or a called electronic signal. As an example, the RF module may include a transceiver, a power amp module (PAM), a frequency filter, or a low noise amplifier (LNA), etc. In addition, the RF module may further include components for transmitting and receiving electromagnetic waves in a free space in wireless communication, for example, conductors or lead wires, etc.

The electronic device 100 according to various embodiments of the present disclosure may include at least one of a server, a TV, a refrigerator, an oven, a clothing styler, a robot cleaner, a drone, an air conditioner, an air cleaner, a PC, a speaker, a home CCTV, an electric light, a washing machine, and a smart plug. Since the components of the electronic device 100 described in FIG. 4 are exemplified as components generally provided in the electronic device, the electronic device 100 according to the embodiment of the present disclosure is not limited to the above-described components and may be omitted and/or added as necessary.

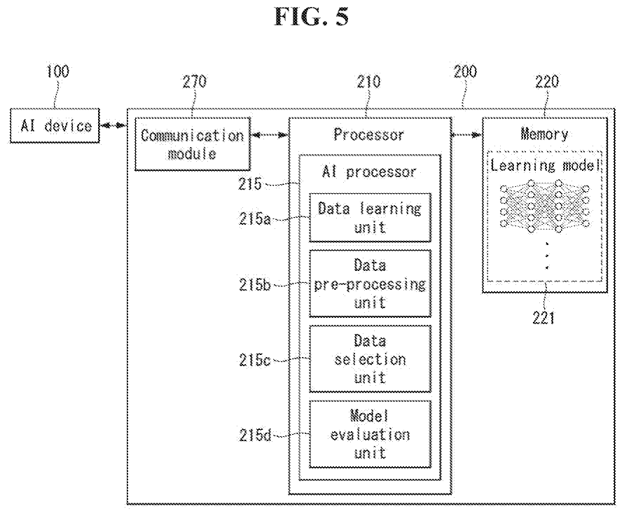

The electronic device 100 may perform an artificial intelligence-based control operation by receiving the AI processing result from a cloud environment shown in FIG. 5, or may perform AI processing in an on-device manner by having an AI module in which components related to the AI process are integrated into one module.

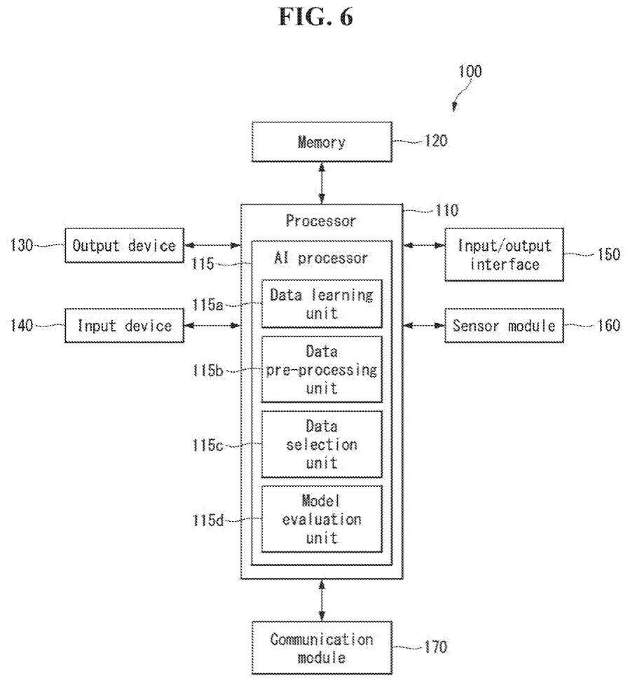

Hereinafter, an AI process performed in a device environment and/or a cloud environment or a server environment will be described with reference to FIGS. 5 and 6. FIG. 5 illustrates an example in which receiving data or signals may be performed in the electronic device 100, but AI processing for processing the input data or signals is performed in the cloud environment. In contrast, FIG. 6 illustrates an example of on-device processing in which the overall operation of AI processing on input data or signals is performed within the electronic device 100.

In FIGS. 5 and 6, the device environment may be referred to as a ‘client device’ or an ‘AI device’, and the cloud environment may be referred to as a ‘server’.

FIG. 5 illustrates a schematic block diagram of an AI server according to an embodiment of the present disclosure.

A server 200 may include a processor 210, a memory 220, and a communication module 270.

An AI processor 215 may learn a neural network using a program stored in the memory 220. In particular, the AI processor 215 may learn the neural network for recognizing data related to the operation of the AI device 100. Here, the neural network may be designed to simulate the human brain structure (e.g. the neuronal structure of the human neural network) on a computer. The neural network may include an input layer, an output layer, and at least one hidden layer. Each layer may include at least one neuron with weights, and the neural network may include a synapse connecting neurons and neurons. In the neural network, each neuron may output an input signal input through the synapse as a function value of an activation function for weight and/or bias.

A plurality of network modes may transmit and receive data according to each connection relationship so that neurons simulate synaptic activity of neurons that transmit and receive signals through the synapses. Here, the neural network may include a deep learning model developed from a neural network model. In the deep learning model, a plurality of network nodes are located on different layers and may exchange data according to a convolution connection relationship. Examples of the neural network model may include various deep learning techniques such as a deep neural network (DNN), a convolutional neural network (CNN), a recurrent neural network, a restricted Boltzmann machine, a deep belief network, and a deep Q-Network, and may be applied in fields such as vision recognition, voice recognition, natural language processing, and voice/signal processing.

On the other hand, the processor 210 performing the functions as described above may be a general-purpose processor (for example, a CPU), but may be a dedicated AI processor (for example, a GPU) for AI learning.

The memory 220 may store various programs and data necessary for the operation of the AI device 100 and/or the server 200. The memory 220 may be accessed by the AI processor 215, and read/write/modify/delete/update data by the AI processor 215. In addition, the memory 220 may store a neural network model (e.g. the deep learning model) generated through a learning algorithm for data classification/recognition according to an embodiment of the present disclosure. Furthermore, the memory 220 may store not only a learning model 221 but also input data, training data, and learning history, etc.

On the other hand, the AI processor 215 may include a data learning unit 215a for learning a neural network for data classification/recognition. The data learning unit 215a may learn criteria regarding what training data to use to determine data classification/recognition, and how to classify and recognize the data using the training data. The data learning unit 215a may learn the deep learning model by acquiring training data to be used for learning and applying the acquired training data to the deep learning model.

The data learning unit 215a may be manufactured in a form of at least one hardware chip and may be mounted on the server 200. For example, the data learning unit 215a may be manufactured in a form of a dedicated hardware chip for artificial intelligence, or may be manufactured as part of a general-purpose processor (CPU) or a dedicated graphics processor (GPU) and mounted on the server 200. In addition, the data learning unit 215a may be implemented as a software module. When implemented as the software module (or a program module including instructions), the software module may be stored in a computer-readable non-transitory computer readable media. In this case, at least one software module may be provided to an operating system (OS), or may be provided by an application.

The data learning unit 215a may learn the neural network model to have criteria for determining how to classify/recognize predetermined data using the acquired training data. At this time, a learning method by a model learning unit may be classified into supervised learning, unsupervised learning, and reinforcement learning. Here, the supervised learning may refer to a method of learning an artificial neural network in a state where a label for training data is given, and the label may mean a correct answer (or a result value) that the artificial neural network must infer when the training data is input to the artificial neural network. The unsupervised learning may mean a method of learning an artificial neural network in a state where the label for training data is not given. The reinforcement learning may mean a method in which an agent defined in a specific environment is learned to select an action or a sequence of actions that maximize cumulative rewards in each state. In addition, the model learning unit may learn the neural network model using a learning algorithm including an error backpropagation method or a gradient decent method. When the neural network model is learned, the learned neural network model may be referred to as the learning model 221. The learning model 221 is stored in the memory 220 and may be used to infer a result for new input data rather than the training data.

On the other hand, the AI processor 215 further include a data pre-processing unit 215b and/or a data selection unit 215c to improve analysis results using the learning model 221, or to save resources or time required to generate the learning model 221.

The data pre-processing unit 215b may pre-process the acquired data so that the acquired data may be used for learning/inference for situation determination. For example, the data pre-processing unit 215b may extract feature information as pre-processing for input data acquired through the input device, and the feature information may be extracted in a format such as a feature vector, a feature point, or a feature map.

The data selection unit 215c may select data necessary for learning among training data or training data pre-processed by the pre-processing unit. The selected training data may be provided to the model learn unit. For example, the data selection unit 215c may select only data for an object included in a specific region as training data by detecting a specific region among images acquired through the camera of the electronic device. In addition, the selection unit 215c may select data necessary for inference among input data acquired through the input device or input data pre-processed by the pre-processing unit.

In addition, the AI processor 215 may further include a model evaluation unit 215d to improve the analysis results of the neural network model. The model evaluation unit 215d may input evaluation data into the neural network model, and when the analysis result output from the evaluation data does not satisfy a predetermined criterion, may cause the model learning unit to learn again. In this case, the evaluation data may be preset data for evaluating the learning model 221. For example, among the analysis results of the learned neural network model for the evaluation data, when the number or ratio of evaluation data whose analysis results are not accurate exceeds a preset threshold, the model evaluation unit 215d may evaluate that a predetermined criterion are not satisfied.

The communication module 270 may transmit the AI processing result by the AI processor 215 to an external electronic device.

As described above, in FIG. 5, an example in which an AI process is implemented in the cloud environment due to computing operation, storage, and power constraints has been described, however, the present disclosure is not limited thereto, and the AI processor 215 may be implemented by being included in a client device. FIG. 6 is an example in which AI processing is implemented in the client device, and is the same as that shown in FIG. 5 except that the AI processor 215 is included in the client device.

FIG. 6 illustrates a schematic block diagram of an AI device according to another embodiment of the present disclosure.

The function of each configuration shown in FIG. 6 may refer to FIG. 5. However, since the AI processor is included in a client device 100, it may not be necessary to communicate with the server (200 in FIG. 5) in performing a process such as data classification/recognition, etc., accordingly, an immediate or real-time data classification/recognition operation is possible. In addition, since it is not necessary to transmit personal information of the user to the server (200 in FIG. 5), it is possible to classify/recognize data for the purpose without leaking the personal information.

On the other hand, each of the components shown in FIGS. 5 and 6 shows functional elements divided functionally, and at least one component may be implemented in a form (e.g. AI module) that is integrated with each other in a real physical environment. It goes without saying that components not disclosed may be included or omitted in addition to the plurality of components shown in FIGS. 5 and 6.

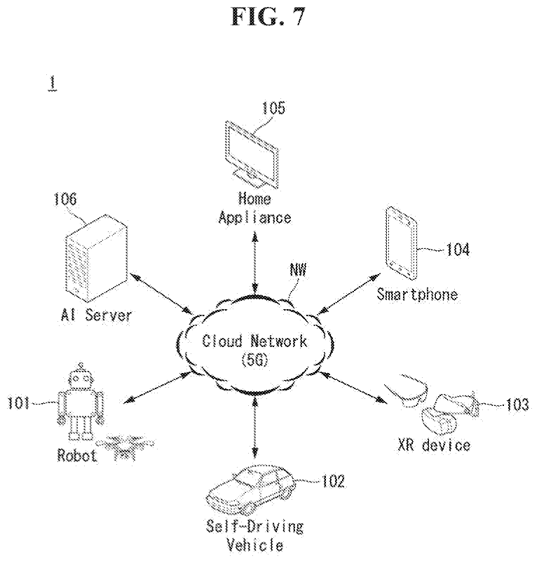

FIG. 7 is a conceptual diagram illustrating an embodiment of an AI device.

Referring to FIG. 7, in an AI system 1, at least one of an AI server 106, a robot 101, a self-driving vehicle 102, an XR device 103, a smartphone 104, or a home appliance 105 are connected to a cloud network NW. Here, the robot 101, the self-driving vehicle 102, the XR device 103, the smartphone 104, or the home appliance 105 applied with the AI technology may be referred to as the AI devices 101 to 105.

The cloud network NW may mean a network that forms a part of a cloud computing infrastructure or exists in the cloud computing infrastructure. Here, the cloud network NW may be configured using the 3G network, the 4G or the Long Term Evolution (LTE) network, or the 5G network.

That is, each of the devices 101 to 106 constituting the AI system 1 may be connected to each other through the cloud network NW. In particular, each of the devices 101 to 106 may communicate with each other through a base station, but may communicate directly with each other without going through the base station.

The AI server 106 may include a server performing AI processing and a server performing operations on big data.

The AI server 106 may be connected to at least one of the robots 101, the self-driving vehicle 102, the XR device 103, the smartphone 104, or the home appliance 105, which are AI devices constituting the AI system, through the cloud network NW, and may assist at least some of the AI processing of the connected AI devices 101 to 105.

At this time, the AI server 106 may learn the artificial neural network according to the machine learning algorithm on behalf of the AI devices 101 to 105, and directly store the learning model or transmit it to the AI devices 101 to 105.

At this time, the AI server 106 may receive input data from the AI devices 101 to 105, infer a result value for the received input data using the learning model, generate a response or a control command based on the inferred result value and transmit it to the AI devices 101 to 105.

Alternatively, the AI devices 101 to 105 may infer the result value for the input data directly using the learning model, and generate a response or a control command based on the inferred result value.

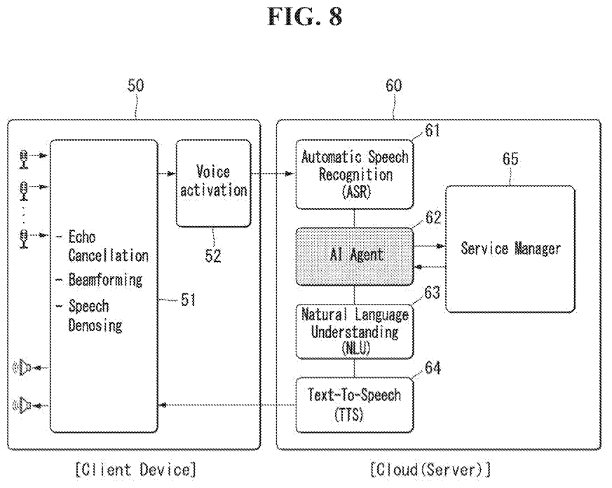

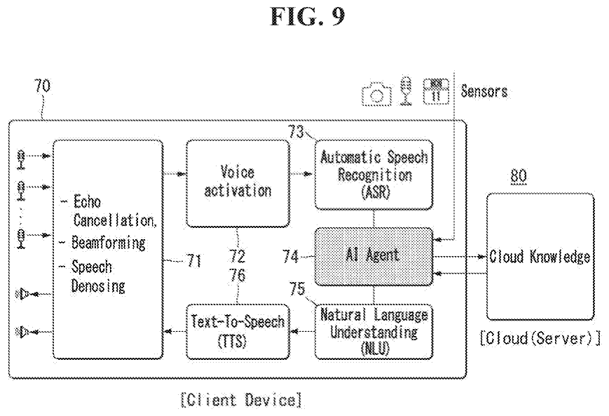

Hereinafter, a speech processing process performed in the device environment and/or the cloud environment or the server environment will be described with reference to FIGS. 8 and 9. FIG. 8 illustrates an example in which the input of speech may be performed in the device 50, but the process of synthesizing the speech by processing the input speech, that is, the overall operation of the speech processing is performed in the cloud environment 60. On the other hand, FIG. 9 illustrates an example of on-device processing in which the overall operation of the speech processing to synthesize the speech by processing the input speech described above is performed in the device 70.

In FIGS. 8 and 9, the device environment 50, 70 may be referred to as a client device, and the cloud environment 60, 80 may be referred to as a server.

FIG. 8 illustrates an exemplary block diagram of a speech processing apparatus in a speech processing system according to an embodiment of the present disclosure.

In an end-to-end speech UI environment, various components are required to process speech events. The sequence for processing the speech event performs speech signal acquisition and playback, speech pre-processing, voice activation, speech recognition, natural language processing and finally, a speech synthesis process in which the device responds to the user.

A client device 50 may include an input module. The input module may receive user input from a user. For example, the input module may receive the user input from a connected external device (e.g. keyboard, headset). In addition, for example, the input module may include a touch screen. In addition, for example, the input module may include a hardware key located on a user terminal.

According to an embodiment, the input module may include at least one microphone capable of receiving a user's speech as a voice signal. The input module may include a speech input system, and may receive a user's speech as a voice signal through the speech input system. The at least one microphone may generate an input signal for audio input, thereby determining a digital input signal for a user's speech. According to an embodiment, a plurality of microphones may be implemented as an array. The array may be arranged in a geometric pattern, for example, a linear geometry, a circular geometry, or any other configuration. For example, for a given point, the array of four sensors may be arranged in a circular pattern separated by 90 degrees to receive sound from four directions. In some implementations, the microphone may include spatially different arrays of sensors in data communication, including a networked array of sensors. The microphone may include omnidirectional, directional (e.g. shotgun microphone), and the like.

The client device 50 may include a pre-processing module 51 capable of pre-processing user input (voice signals) received through the input module (e.g. microphone).

The pre-processing module 51 may remove an echo included in a user voice signal input through the microphone by including an adaptive echo canceller (AEC) function. The pre-processing module 51 may remove background noise included in the user input by including a noise suppression (NS) function. The pre-processing module 51 may detect an end point of a user's voice and find a part where the user's voice is present by including an end-point detect (EPD) function. In addition, the pre-processing module 51 may adjust a volume of the user input to be suitable for recognizing and processing the user input by including an automatic gain control (AGC) function.

The client device 50 may include a voice activation module 52. The voice activation module 52 may recognize a wake up command that recognizes a user's call. The voice activation module 52 may detect a predetermined keyword (e.g. Hi LG) from the user input that has undergone a pre-processing process. The voice activation module 52 may exist in a standby state to perform an always-on keyword detection function.

The client device 50 may transmit a user voice input to a cloud server. Automatic speech recognition (ASR) and natural language understanding (NLU) operations, which are core components for processing user voice, are traditionally executed in the cloud due to computing, storage, and power constraints. The cloud may include a cloud device 60 that processes user input transmitted from a client. The cloud device 60 may exist in the form of a server.

The cloud device 60 may include an automatic speech recognition (ASR) module 61, an artificial intelligent agent 62, a natural language understanding (NLU) module 63, a text-to-speech (TTS) module 64, and a service manager 65.

The ASR module 61 may convert the user voice input received from the client device 50 into text data.

The ASR module 61 includes a front-end speech pre-processor. The front-end speech pre-processor extracts representative features from speech input. For example, the front-end speech pre-processor performs Fourier transformation of the speech input to extract spectral features that characterize the speech input as a sequence of representative multidimensional vectors. In addition, the ASR module 61 may include one or more speech recognition models (e.g. acoustic models and/or language models) and implement one or more speech recognition engines. Examples of the speech recognition models include hidden Markov models, Gaussian-Mixture Models, deep neural network models, n-gram language models, and other statistical models. Examples of the speech recognition engines include dynamic time distortion-based engines and weighted finite state transducer (WFST)-based engines. The one or more speech recognition models and the one or more speech recognition engines may be used to process the extracted representative features of the front-end speech pre-processor to generate intermediate recognition results (e.g. phonemes, phoneme strings, and sub-words), and ultimately text recognition results (e.g. words, word strings, or a sequence of tokens).

When the ASR module 61 generates recognition results including text strings (e.g. words, or a sequence of words, or a sequence of tokens), the recognition results are transmitted to a natural language processing module 732 for intention inference. In some examples, the ASR module 61 generates multiple candidate text representations of the speech input. Each candidate text representation is a sequence of words or tokens corresponding to the speech input.

The NLU module 63 may grasp user intention by performing syntactic analysis or semantic analysis. The syntactic analysis may divide syntactic units (e.g. words, phrases, morphemes, etc.) and determine what syntactic elements the divided units have. The semantic analysis may be performed using semantic matching, rule matching, or formula matching, etc. Accordingly, the NUL module 63 may acquire a domain, an intention, or a parameter necessary for expressing the intention by a user input.

The NLU module 63 may determine a user's intention and parameters using a mapping rule divided into domains, intentions, and parameters required to grasp the intentions. For example, one domain (e.g. an alarm) may include a plurality of intentions (e.g., alarm set, alarm off), and one intention may include a plurality of parameters (e.g. time, number of repetitions, alarm sound, etc.). A plurality of rules may include, for example, one or more essential element parameters. The matching rule may be stored in a natural language understanding database.

The NLU module 63 grasps the meaning of words extracted from user input by using linguistic features (for example, syntactic elements) such as morphemes and phrases, and determines the user's intention by matching the meaning of the grasped word to a domain and an intention. For example, the NLU module 63 may determine the user intention by calculating how many words extracted from the user input are included in each domain and intention. According to an embodiment, the NLU module 63 may determine a parameter of the user input using words that were the basis for grasping the intention. According to an embodiment, the NLU module 63 may determine the user's intention using the natural language recognition database in which linguistic features for grasping the intention of the user input are stored. In addition, according to an embodiment, the NLU module 63 may determine the user's intention using a personal language model (PLM). For example, the NLU module 63 may determine the user's intention using personalized information (e.g. contact list, music list, schedule information, social network information, etc.). The personal language model may be stored, for example, in the natural language recognition database. According to an embodiment, the ASR module 61 as well as the NLU module 63 may recognize the user's voice by referring to the personal language model stored in the natural language recognition database.

The NLU module 63 may further include a natural language generation module (not shown). The natural language generation module may change designated information into the form of text. The information changed into the text form may be in the form of natural language speech. The designated information may include, for example, information about additional input, information guiding completion of an operation corresponding to the user input, or information guiding an additional input of the user, etc. The Information changed into the text form may be transmitted to the client device and displayed on a display, or transmitted to a TTS module to be changed to a voice form.

A speech synthesis module (TTS module 64) may change text-type information into voice-type information. The TTS module 64 may receive the text-type information from the natural language generation module of the NLU module 63, and change the text-type information into the voice-type information and transmit it to the client device 50. The client device 50 may output the voice-type information through the speaker.

The speech synthesis module 64 synthesizes speech output based on a provided text. For example, results generated by the automatic speech recognition (ASR) module 61 are in the form of a text string. The speech synthesis module 64 converts the text string into audible speech output. The speech synthesis module 64 uses any suitable speech synthesis technique to generate speech output from texts, which includes concatenative synthesis, unit selection synthesis, diphone synthesis, domain-specific synthesis, formant synthesis, articulatory synthesis, hidden Markov model (HMM)-based synthesis, and sinewave synthesis, but is not limited thereto.

In some examples, the speech synthesis module 64 is configured to synthesize individual words based on the phoneme string corresponding to the words. For example, the phoneme string is associated with a word in the generated text string. The phoneme string is stored in metadata associated with words. The speech synthesis module 64 is configured to directly process the phoneme string in the metadata to synthesize speech-type words.

Since the cloud environments usually have more processing power or resources than the client devices, it is possible to acquire a speech output of higher quality than actual in client-side synthesis. However, the present disclosure is not limited to this, and it goes without saying that a speech synthesis process may be performed on the client side (see FIG. 9).

On the other hand, according to an embodiment of the present disclosure, the cloud environment may further include an artificial intelligence (AI) agent 62. The AI agent 62 may be designed to perform at least some of the functions performed by the ASR module 61, the NLU module 63, and/or the TTS module 64 described above. In addition, the AI agent module 62 may contribute to perform an independent function of each of the ASR module 61, the NLU module 63, and/or the TTS module 64.

The AI agent module 62 may perform the functions described above through deep learning. The deep learning represents data in a form (for example, in a case of an image, pixel information is expressed as a column vector) that the computer can understand when there is any data, and many studies (how to make better representation techniques and how to build a model to learn them) are being conducted to apply this to learning. As a result of these efforts, various deep learning techniques such as deep neural networks (DNN), convolutional deep neural networks (CNN), recurrent Boltzmann machine (RNN), restricted Boltzmann machine (RBM), deep belief networks (DBN), deep Q-network may be applied to fields such as computer vision, speech recognition, natural language processing, and voice/signal processing.

Currently, all major commercial speech recognition systems (MS Cortana, Skype translator, Google Now, Apple Siri, etc.) are based on deep learning techniques.

In particular, the AI agent module 62 may perform various natural language processing processes including machine translation, emotion analysis, information retrieval using deep artificial neural network structure in the field of natural language processing.

On the other hand, the cloud environment may include a service manager 65 capable of collecting various personalized information and supporting the function of the AI agent 62. The personalized information acquired through the service manager may include at least one data (calendar application, messaging service, music application use, etc.) that the client device 50 uses through the cloud environment, at least one sensing data (camera, microphone, temperature, humidity, gyro sensor, C-V2X, pulse, ambient light, iris scan, etc.) that the client device 50 and/or cloud 60 collect, and off device data not directly related to the client device 50. For example, the personalized information may include maps, SMS, news, music, stock, weather, Wikipedia information.

The AI agent 62 is represented in separate blocks to be distinguished from the ASR module 61, the NLU module 63, and the TTS module 64 for convenience of description, but the AI agent 62 may perform functions of at least a part or all of the modules 61, 62, and 64.

In the above, FIG. 8 has described an example in which the AI agent 62 is implemented in the cloud environment due to computing operation, storage, and power constraints, but the present disclosure is not limited thereto.

For example, FIG. 9 is the same as that shown in FIG. 8, except that the AI agent is included in the client device.

FIG. 9 illustrates an exemplary block diagram of a speech processing apparatus in a speech processing system according to another embodiment of the present disclosure. A client device 70 and a cloud environment 80 illustrated in FIG. 9 may correspond only with differences in some configurations and functions of the client device 50 and the cloud environment 60 mentioned in FIG. 8. Accordingly, FIG. 8 may be referred to a specific function of the corresponding block.

Referring to FIG. 9, the client device 70 may include a pre-processing module 51, a voice activation module 72, an ASR module 73, an AI agent 74, an NLU module 75, and a TTS module 76. In addition, the client device 70 may include an input module (at least one microphone) and at least one output module.

In addition, the cloud environment may include cloud knowledge 80 that stores personalized information in the form of knowledge.

The function of each module illustrated in FIG. 9 may refer to FIG. 8. However, since the ASR module 73, the NLU module 75, and the TTS module 76 are included in the client device 70, communication with the cloud may not be necessary for speech processing such as speech recognition and speech synthesis. Accordingly, an instant and real-time speech processing operation is possible.

Each module illustrated in FIGS. 8 and 9 is only an example for explaining a speech processing process, and may have more or fewer modules than the modules illustrated in FIGS. 8 and 9. It should also be noted that two or more modules may be combined or have different modules or different arrangements of modules. The various modules shown in FIGS. 8 and 9 may be implemented with software instructions, firmware, or a combination thereof for processing by one or more signal processing and/or on-demand integrated circuits, hardware, or one or more processors.

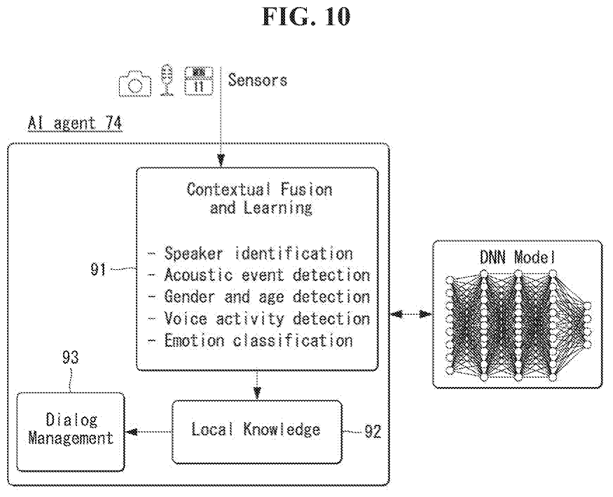

FIG. 10 illustrates an exemplary block diagram of an artificial intelligent agent according to an embodiment of the present disclosure.

Referring to FIG. 10, the AI agent 74 may support interactive operation with a user in addition to performing ASR operation, NLU operation, and TTS operation in the speech processing described through FIGS. X1 and X2. Alternatively, the AI agent 74 may contribute to the NLU module 63 that performs an operation of clarifying, supplementing, or additionally defining information included in text expressions received from the ASR module 61 using context information.

Here, the context information may include client device user preferences, hardware and/or software states of the client device, various sensor information collected before, during, or immediately after user input, previous interactions (e.g. conversations) between the AI agent and the user. It goes without saying that the context information in the present disclosure is dynamic and varies depending on time, location, content of the conversation and other factors.

The AI agent 74 may further include a contextual fusion and learning module 91, a local knowledge 92, and a dialog management 93.

The contextual fusion and learning module 91 may learn a user's intention based on at least one data. The at least one data may include at least one sensing data acquired in a client device or a cloud environment. In addition, the at least one data may include speaker identification, acoustic event detection, speaker's personal information (gender and age detection), voice activity detection (VAD), emotion classification.

The speaker identification may refer to specifying a person who speaks in a registered conversation group by voice. The speaker identification may include a process of identifying a previously registered speaker or registering a new speaker. Acoustic event detection may detect a type of sound and a location of the sound by detecting the sound itself beyond speech recognition technology. Voice activity detection (VAD) is a speech processing technique of detecting the presence or absence of human speech (voice) in an audio signal which may include music, noise or other sound. According to an example, the intelligent agent 74 may determine whether speech is present from the input audio signal. According to an example, the intelligent agent 74 may distinguish between speech data and non-speech data using a deep neural network (DNN) model. In addition, the intelligent agent 74 may perform an emotion classification operation on speech data using the DNN model. Speech data may be classified into anger, boredom, fear, happiness, and sadness according to the emotion classification operation.

The context fusion and learning module 91 may include the DNN model to perform the operation described above and may determine an intention of a user input based on sensing information collected from the DNN model or a client device or collected in a cloud environment.

The at least one data is merely an example and any data that may be referenced to determine the user's intention in a voice processing process may be included. The at least one data may be acquired through the DNN model described above.

The intelligent agent 74 may include a local knowledge 92. The local knowledge 92 may include user data. The user data may include a user's preference, a user address, a user's initial setting language, and a user's contact list. According to an example, the intelligent agent 74 may additionally define user intention by supplementing information included in the user's voice input using specific information of the user. For example, in response to a user's request “Invite my friends to my birthday party”, the intelligent agent 74 may use the local knowledge 92 to determine who the “friends” are and when and where the “birthday party” will be given, without asking the user to provide more clear information.

The intelligent agent 74 may further include a dialog management 93. The dialog management 93 may be referred to as a dialog manager. The dialog manager 93 is a basic component of a voice recognition system and may manage essential information to generate an answer to a user intention analyzed by NLP. In addition, the dialog manager 93 may detect a barge-in event for receiving a user's voice input while a synthesized voice is output through a speaker in the TTS system.

The intelligent agent 74 may provide a dialog interface to enable voice conversation with a user. The dialog interface may refer to a process of outputting a response to a user's voice input through a display or a speaker. Here, a final result output through the dialog interface may be based on the ASR operation, NLU operation, and TTS operation described above.

Meanwhile, in the data processing system, while listening to a conversation between a first speaker and a second speaker, conversation thereof may be collected and the collected conversation may be shared with an agent of the first speaker and an agent of the second speaker, and here, the agent of the first speaker and the agent of the second speaker may cooperate on an analysis of an intention for a request from the first speaker or the second speaker or a response thereto.

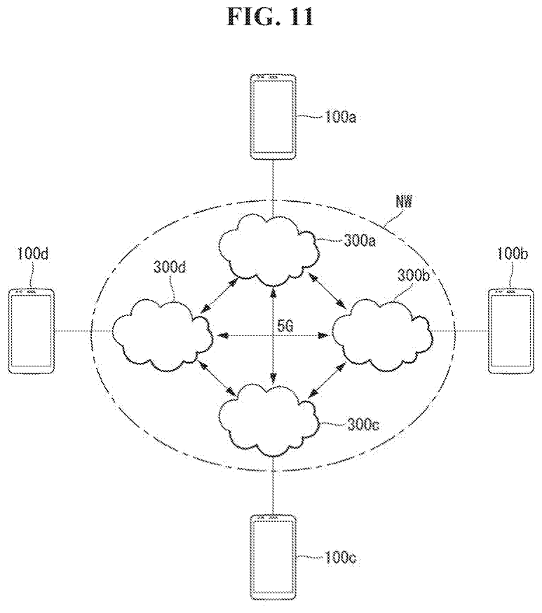

FIG. 11 is a diagram illustrating a relationship between a smart device and an agent according to an embodiment of the present disclosure.

Referring to FIG. 11, the cloud may include at least one agent 300a to 300d. A cloud NW may be referred to as a cloud device, a cloud environment, or a cloud network. The agents 300a to 300d may be referred to as artificial intelligence agents (AI agents). Detailed functions of the intelligent agent have been sufficiently described in FIGS. 8 to 10, and thus will be omitted.

The at least one agent 300a to 300d may share information with each other in the cloud. The at least agents 300a to 300d may perform an authentication procedure before sharing information with each other and may cooperate while sharing information with each other after the authentication procedure is normally processed.

As shown in FIG. 11, the at least one agent 300a to 300d may include a first agent 300a to a fourth agent 300d.

The first agent 300a may store local knowledge including personal information of the first speaker. The personal information of the first speaker may be referred to as first user data or data of the first speaker. The personal information of the first speaker may include a preference of the first speaker, an address of the first speaker, an initial setting language of the first speaker, a contact list of the first speaker, and the like. The first agent 300a may be referred to as an agent 300a of the first speaker.

Since the second agent 300b to the fourth agent 300d have substantially the same function, configuration, and effect as the first agent 300a, a description thereof will be omitted. The second agent 300b to the fourth agent 300d may be referred to as an agent 300b of a second speaker to an agent 300d of a fourth speaker, respectively.

The first agent 300a may be electrically connected to the first smart device 100a. For example, the first speaker or the first user may access the first agent 300a by logging in through the first smart device 100a. The first smart device 100a may include a smart phone, a smart pad, a mobile device, an electronic device, and the like.

In addition, when the second speaker or the second user is normally authenticated through the first smart device 100a, the first agent 300a may be connected to the second agent 300b and share information with the second agent 300b.

The second agent 300b may be electrically connected to the second smart device 100b, the third agent 300c may be electrically connected to the third smart device 100c, and the fourth agent 300d may be electrically connected to the fourth smart device 100d.

As described above, in the present disclosure, the agents in the cloud may cooperate with each other in the mobile device or the smart device in the cloud environment, while sharing information between the multiple agents according to permission of the user.

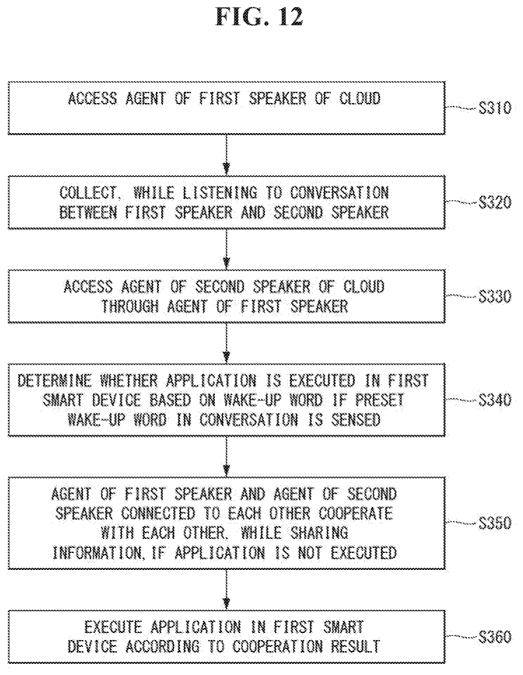

FIG. 12 is a diagram illustrating a data processing method based on artificial intelligence according to an embodiment of the present disclosure.

Referring to FIG. 12, a data processing method based on artificial intelligence according to an embodiment of the present disclosure includes a first speaker connection step, a collection step, a second speaker connection step, a determination step, a cooperation step, and an execution step.

In the first speaker connection step, the agent 300a of the first speaker in the cloud may be accessed (S310). The first speaker may access the first agent 300a in the cloud using his smart device. For example, the first speaker may access the agent 300a of the first speaker by logging in to an agent application displayed on the first smart device 100a.

In the collection step, while listening to a conversation between the first speaker and the second speaker using the first smart device 100a connected to the agent 300a of the first speaker, conversation may be collected (S320). The first smart device 100a may listen to contents spoken by the first and second speakers using a microphone or the like.

The first smart device 100a may display a recognition signal or recognition message for indicating that the conversation of the first and second speakers is collected before collecting the conversation of the first and second speaker. For example, the acknowledgment signal or the acknowledgment message may include content regarding collection of personal information.

For example, the first smart device 100a may transmit a recognition signal or a recognition message to the second smart device 100b, which is a smart device of the second speaker. The first smart device 100a may collect the conversation after a consent for connecting personal information of the second speaker is granted from the second smart device 100b.

In the second speaker connection step, the agent 300b of the second speaker in the cloud may be accessed through the agent 300a of the first speaker (S330). The first smart device 100a may identify the second speaker based on a voice or voice data of the second speaker who speaks.

For example, the voice or voice data of the second speaker may include at least one sensing data acquired in the first smart device 100a, a client device, or a cloud environment. For example, the voice or voice data of the second speaker may include speaker identification, acoustic event detection, speaker's personal information (gender and age detection), and voice activity detection (VAD), and emotion information (emotion classification). Speaker identification may refer to specifying a speaker who speaks in a registered conversation group by voice. The speaker identification may include a process of identifying a previously registered speaker or registering a new speaker.

The agent 300a of the first speaker may be provided with information on the second speaker from the first smart device 100a and access the agent 300b of the second speaker based on the information on the second speaker.

In the determination step, when a preset wake-up word is sensed in the conversation, it may be determined whether an application is executed in the first smart device 100a based on the wake-up word (S340). The agent 300a of the first speaker may recognize a wake-up command for recognizing a call of the first speaker or the second speaker through the first smart device 100a. The agent 300a of the first speaker may detect a wake-up word which is a predetermined keyword (e.g., Hi LG) from the input of the first speaker or the second speaker that has undergone a preprocessing process through the first smart device 100a. The first smart device 100a may exist in a standby state to perform an always-on keyword detection function. That is, when a wake-up word is input through the first smart device 100a, the agent 300a of the first speaker may activate the first smart device 100a. For example, the wake-up word may be “Hi, LG”, but is not limited thereto. The agent 300a of the first speaker may be switched to a wake-up mode for speech recognition in response to the voice input including the wake-up word of the first speaker or the second speaker using the first smart device 100a.

The agent 300a of the first speaker may search for an application that may be executed in response to the wake-up word, and determine whether the application is executed in the first smart device 100a based on the search result.

In the cooperation step, when the application is not executed, the agent 300a of the connected first speaker and the agent 300b of the second speaker may cooperate with each other, while sharing information with each other (S350). When the application is not executed, the agent 300a of the first speaker may transmit information on an application that may be executed to correspond to the wake-up word to the agent 300b of the second speaker. The agent 300b of the second speaker may search for information on the application transmitted from the agent 300a of the first speaker, and transmit response information, which is a search result, to the agent 300a of the first speaker. For example, the response information may include an application that may be executed in response to the wake-up word, various application information related thereto, and a store from which the application may be downloaded.

The agent 300a of the first speaker may learn based on response information transmitted from the agent 300b of the second speaker, and may provide the same to the first smart device 100a.

In the execution step, the application may be executed in the first smart device 100a according to a result of the cooperation (S360). The first smart device 100a may execute an application based on the response information under the control of the agent 300a of the first speaker.

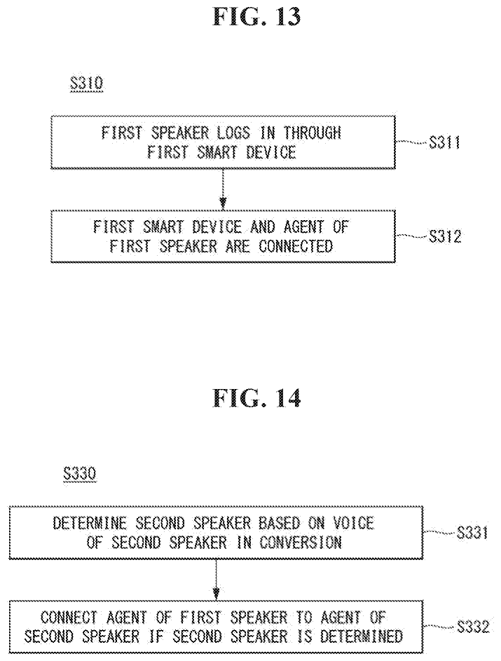

FIG. 13 is a diagram illustrating a process in which a first smart device and an agent of a first speaker are connected according to an embodiment of the present disclosure.

Referring to FIG. 13, the step of accessing the agent 300a of the first speaker in the cloud may include a log-in step and a connection step.

In the log-in step, the first speaker may log in through the first smart device 100a (S311). The first speaker may access the agent 300a of the first speaker through the first smart device 100a by inputting an ID/password. For example, the ID may be a personal Google account, a phone number, or an ID created by a user. The password may be a password high security. The password may be set according to characteristics of the mobile device or smart device or a user setting. In the log-in step, in case of registering for the first time, a high security type password may be required, but once registered, log in may be performed with a relatively low security type password. For example, the high security type password may be set by combining numbers, upper and lower case letters, special characters, and a length of the password. The relatively low security type password may be set with numbers, upper and lower case letters, or a combination thereof.

In the connection step, the first smart device 100a and the agent 100a of the first speaker may be connected (S312). The first speaker may be connected to the agent 300a of the first speaker through the first smart device 100a and display various information or the like of the connected agent 300a of the first speaker on the first smart device 100a or execute the same in the first smart device 100a.

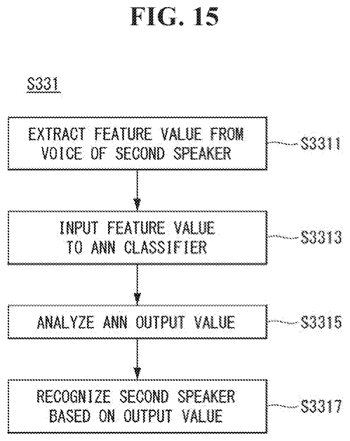

FIG. 14 is a diagram illustrating a process of accessing an agent of a second speaker using an agent of a first speaker according to an embodiment of the present disclosure.

Referring to FIG. 14, the step of accessing the agent 300b of the second speaker may include a determination step and a connection step.

In the determination step, the second speaker may be determined based on a voice of the second speaker in conversation (S331). In the determination step, the second speaker may be determined based on the voice or voice data of the second speaker. For example, the voice or voice data of the second speaker may include at least one sensing data acquired from the first smart device 100a, a client device, or a cloud environment. For example, the voice or voice data of the second speaker may include speaker identification, acoustic event detection, speaker's personal information (gender and age detection), and voice activity detection (VAD), and emotion information (emotion classification). Speaker identification may refer to specifying a speaker who speaks in a registered conversation group by voice. The speaker identification may include a process of determining a previously registered speaker or registering a new speaker.

In the connection step, if the second speaker is determined, the agent 300a of the first speaker may be connected to the agent 300b of the second speaker (S332). The agent 300a of the first speaker may receive information on the second speaker from the first smart device 100a and may access the agent 300b of the second speaker based on the information on the second speaker.

FIG. 15 is a diagram illustrating an example of determining a second speaker according to an embodiment of the present disclosure.

Referring to FIG. 15, the first smart device 100a may include a processor (see 110 of FIGS. 4 and 6).

The processor 110 may extract feature values from sensing information acquired through at least one sensor in order to determine the second speaker (S3311). The sensing information is the voice of the second speaker or may be voice data of the second speaker.

For example, the processor 110 may receive the voice of the second speaker from at least one sensor (e.g., a microphone). The processor may extract a feature value from the voice of the second speaker. The feature value is determined to specifically represent the second speaker among at least one feature that may be extracted from the voice of the second speaker.

The processor 110 may control the feature values to be input to an artificial neural network (ANN) classifier trained to distinguish a second speaker among a plurality of speakers (S3313).

The processor 110 may generate a speaker identification input by combining the extracted feature value. The speaker identification input may be input to the ANN classifier trained to distinguish a second speaker from among a plurality of speakers based on the extracted feature value.

The processor 110 may analyze an output value of the ANN (S3315) and determine the second speaker based on the output value of the ANN (S3317).

The processor 110 may accurately identify the second speaker from the output of the ANN classifier.

Meanwhile, in FIG. 15, an example in which the operation of identifying the second speaker through AI processing is implemented in the processing of the first smart device 100a has been described, but the present disclosure is not limited thereto. For example, the AI processing may be performed in a 5G network or cloud environment based on sensing information received from the first smart device 100a.

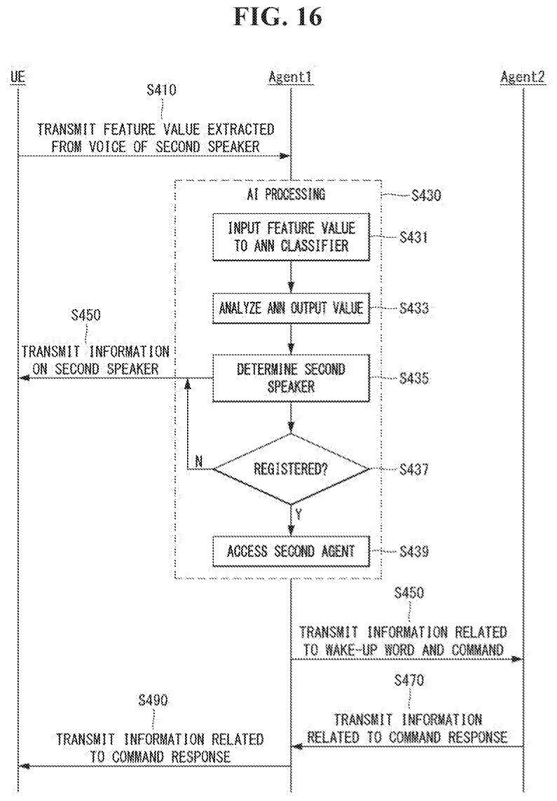

FIG. 16 is a diagram illustrating another example of determining a second speaker according to an embodiment of the present disclosure.

The processor may control the transceiver to transmit the voice of the second speaker or the voice data of the second speaker to the AI processor included in the 5G network. In addition, the processor may control the transceiver to receive AI processed information from the AI processor.

The AI-processed information may be information indicating whether the speaker is the second speaker.

Meanwhile, the first smart device 100a may perform an initial access procedure with the 5G network in order to transmit the voice of the second speaker or the voice data of the second speaker to the 5G network. The first smart device 100a may perform an initial access procedure with the 5G network based on a synchronization signal block (SSB).

In addition, the first smart device 100a may receive, from a network, downlink control information (DCI) used for scheduling transmission of the voice of the second speaker or the voice data of the second speaker acquired from at least one sensor provided in the first smart device 100a through a transceiver.

The processor 110 may transmit the voice of the second speaker or voice data of the second speaker to the network based on the DCI.

The voice of the second speaker or voice data of the second speaker may be transmitted to the network via a PUSCH, and the SSB and a demodulation reference signal (DM-RS) of the PUSCH may be quasi-co-located (QCL) for a QCL type D.

Referring to FIG. 16, the first smart device 100a may transmit a feature value extracted from the voice of the second speaker or the voice data of the second speaker which is the sensing information to the 5G network (S410).

Here, the 5G network may include the agent 300a (agent1) of the first speaker. The agent 300a (agent1) of the first speaker may include an AI processor or an AI system. The AI system of the 5G network may perform AI processing based on the received sensing information (S430).

The AI system may input feature values received from the first smart device 100a to the ANN classifier (S431). The AI system may analyze an ANN output value (S433) and determine the second speaker from the ANN output value (S435). The 5G network may transmit the information on the second speaker determined by the AI system to the first smart device 100a through the transceiver.

Here, the information on the second speaker may include a phone number, an SNS, a state included in KakaoTalk, and the like previously registered in the agent 300a (agent1) of the first speaker.

When the second speaker is determined (S435), the AI system may check whether the second speaker has been registered in the agent 300a (agent1) of the first speaker. When the second speaker is registered in the agent 300a (agent1) of the first speaker (S437), the AI system may access the agent 300b (agent2) of the second speaker (S439).

The agent 300a (agent1) of the first speaker may transmit information related to a wake-up word or a command to the agent 300b (agent2) of the second speaker (S450), and receive information related to a command response from the agent 300b (agent2) of the second speaker (S470). The agent 300a (agent1) of the first speaker may learn based on the information related to the command response and may update based on the learned information.

In addition, the agent 300a (agent1) of the first speaker may transmit information related to the command response or updated information based on the learned information to the first smart device 100a (S490).

Meanwhile, the first smart device 100a may transmit only the sensing information to the 5G network and extract a feature value corresponding to the speaker identification input to be used as an input of the ANN for determining the second speaker from the sensing information from the AI system included in the 5G network.

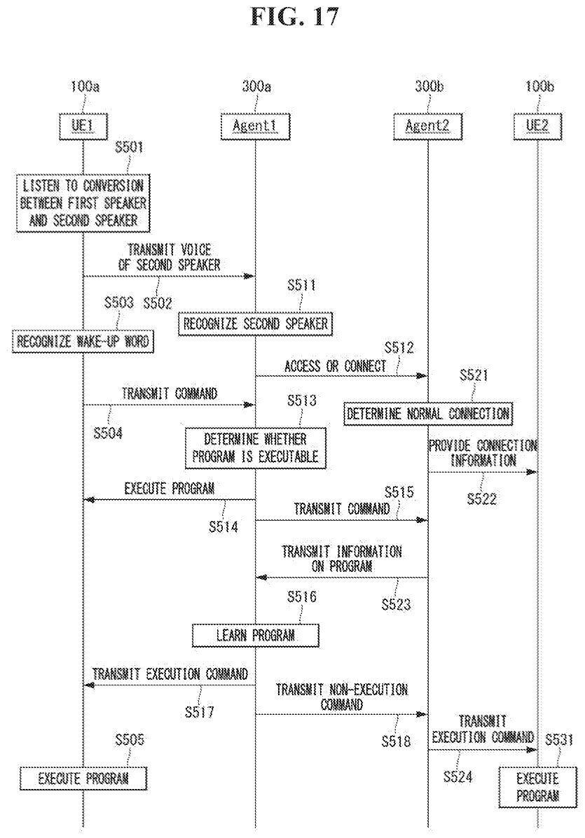

FIG. 17 is a diagram illustrating a data processing method based on artificial intelligence according to another embodiment of the present disclosure.

Referring to FIG. 17, the first speaker may access the agent 300a (agent1) of the first speaker through the first smart device 100a (UE1). The first smart device 100a (UE1) may listen to conversation between the first speaker and the second speaker under the control of the agent 300a (agent1) of the first speaker (S501).

The first smart device 100a (UE1) may transmit conversation listened between the first speaker and the second speaker to the agent 300a (agent1) of the first speaker (S502). The first smart device 100a (UE1) may transmit the voice of the second speaker or the voice data of the second speaker to the agent 300a (agent1) of the first speaker.

The first smart device 100a (UE1) or the agent 300a (agent1) of the first speaker may extract a feature value from the voice of the second speaker or the voice data of the second speaker and determine the second speaker based on the extracted feature value (S511). Details thereof have been sufficiently described above and thus are omitted here.

When the second speaker is determined (S511), the agent 300a (agent1) of the first speaker may be connected to the agent 300b of the second speaker (S512). The agent 300b (agent2) of the second speaker may be provided with information on the second speaker from the agent 300a (agent1) of the first speaker and determine whether connection has been normally made (S521). The agent 300b (agent2) of the second speaker may provide information on normal connection to the second smart device 100b (UE2) (S522).

The first smart device 100a (UE1) may recognize a wake-up word in conversation between the first speaker and the second speaker (S503). When the wake-up word is recognized (S503), the first smart device 100a (UE1) may transmit a command or information on the user's request to the agent 300a (agent1) of the first speaker (S504).

The agent 300a (agent1) of the first speaker may determine whether a program is executable based on the command or information on the user's request (S513). The program may be referred to as an application.

If it is determined that the program may be executed based on the command or information on the user's request (S513), the agent (300a, agent1) of the first speaker may control the first smart device 100a (UE1) to execute the program (S514).

When it is determined that it is impossible to execute the program based on the command or information on the user's request (S513), the agent 300a of the first speaker may transmit the command or information on the user's request to the agent 300b (agent2) of the second speaker (S515).

The agent 300b (agent2) of the second speaker may search for a program based on the transmitted command or information on the user's request, and transmit the information on the program to the agent 300a (agent1) of the first speaker (S523).

The agent 300a (agent1) of the first speaker may learn the program upon receiving the information on the program from the agent 300b (agent2) of the second speaker (S516). The agent 300a (agent1) of the first speaker may determine whether it is executable in the first smart device 100a (UE1) based on the learned program.

When it is determined that it is executable in the first smart device 100a (UE1) based on the learned program, the agent 300a (agent1) of the first speaker may transmit an execution command to the first smart device 100a (UE1) (S517). When the execution command is transmitted (S517), the first smart device 100a (UE1) may execute the program to correspond thereto (S505).

Meanwhile, when it is determined that it is not executable in the first smart device 100a (UE1) based on the learned program, the agent 300a (agent1) of the first speaker may transmit a non-execution command to the agent 300b (agent2) of the second speaker (S518).

When the non-execution command is transmitted from the agent 300a (agent1) of the first speaker (S518), the agent 300b (agent2) of the second speaker may transmit an execution command to the second smart device 100b (UE2) (S524). When the execution command is transmitted (S524), the second smart device 100b (UE2) may execute a program to correspond thereto (S531).

As described above, in the present disclosure, the agent 300a (agent1) of the first speaker and the agent 300b (agent2) of the second speaker in the cloud may share the command of the first speaker or the second speaker and information based on their request in the smart device of the cloud environment and cooperate with each other to execute the shared information, thereby simply learning different information which does not overlap.

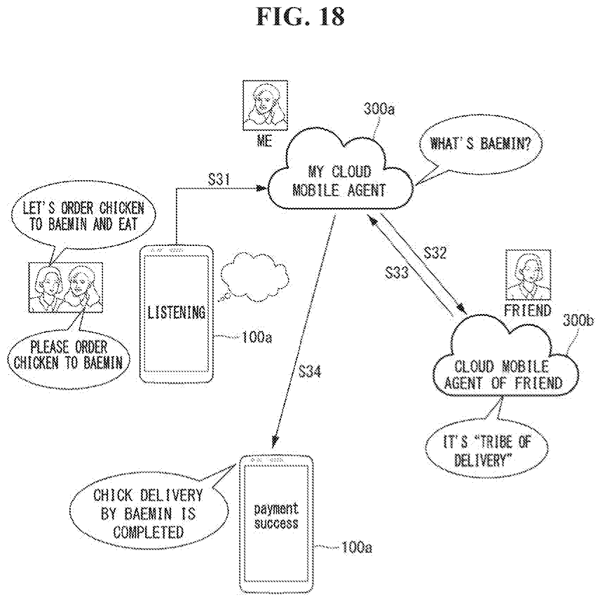

FIG. 18 is a diagram illustrating an example of a data processing method based on artificial intelligence according to an embodiment of the present disclosure.

Referring to FIG. 18, a plurality of agents according to an embodiment of the present disclosure may be evolved based on information sharing between agents in the cloud environment.

The first smart device 100a may listen to conversation between the first speaker and the second speaker in real time. The first speaker may be referred to as I or the user. The second speaker may be called a friend.

When the first smart device 100a does not correctly understand a question of the first speaker, it may check whether there is information on the second speaker. The information of the second speaker may include face information of the friend or voice information of the friend.

The first smart device 100a may transmit information of the second speaker to the agent 300a of the first speaker (S31).

The agent 300a of the first speaker may authenticate based on the transmitted information of the second speaker and access the agent 300b of the second speaker. For example, the agent 300a of the first speaker may authenticate based on the face of the second speaker or the voice of the second speaker.

When the agent 300a of the first speaker is connected to the agent 300b of the second speaker, it may request the agent 300b of the second speaker for information on a part thereof which is not correctly understood, thereby sharing the information on the part of the question which is not correctly understood. When the agent 300b of the second speaker knows the requested information, it may transfer or transmit the information thereon to the agent 300a of the first speaker (S33).

The agent 300a of the first speaker may receive and learn the requested information and may perform upgrading or updating so as to be evolved. The agent 300a of the first speaker may perform a user request through the first smart device 100a based on the upgraded information (S34).

For example, if the second speaker utters “Let's order chicken to Baemin and eat” and then the first speaker utters “Please order chicken to Baemin”, the first smart device 100a may listen to conversation therebetween. If the first smart device 100a does not recognize the term “Baemin” in the conversation, the first smart device 100a may transmit information on the “Baemin” and the information of the second speaker to the agent 300a of the first speaker.

The agent 300a of the first speaker may authenticate based on the information of the second speaker, access the agent 300b of the second speaker, and request information on “Baemin.”

If the agent 300b of the second speaker knows the information on the requested “Baemin”, the information indicating that the “Baemin” is “Tribe of delivery” may be transmitted to the agent 300a of the first speaker.

Upon receiving the information indicating that the “Baemin” is “Tribe of delivery”, the agent 300a of the first speaker may upgrade intelligence so as to be evolved. The agent 300a of the first speaker may transmit the information of “Tribe of delivery” to the first smart device 100a to perform the “Please order chicken to Baemin” requested by the first speaker. Accordingly, the first smart device 100a may execute an application of “Tribe of delivery” so that chicken may be delivered through the application of “Tribe of delivery.”

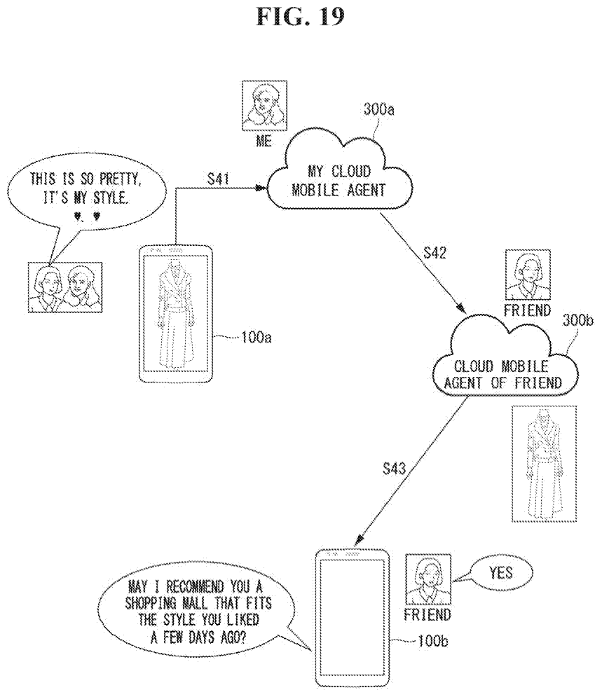

FIG. 19 is a diagram illustrating another example of a data processing method based on artificial intelligence according to an embodiment of the present disclosure.

Referring to FIG. 19, a plurality of agents according to an embodiment of the present disclosure may be evolved by constantly exchanging information between agents in a cloud environment.

The first smart device 100a may listen to conversation of the first speaker and the second speaker in real time.

The first smart device 100a may transmit information of the second speaker who is speaking to the agent 300a of the first speaker (S41).

The agent 300a of the first speaker may authenticate based on the transmitted information of the second speaker and access the agent 300b of the second speaker. For example, the agent 300a of the first speaker may authenticate based on a face of the second speaker or a voice of the second speaker.

When the agent 300a of the first speaker is connected to the agent 300b of the second speaker, the agent 300a of the first speaker may transmit speech information of the second speaker based on contents spoken by the second speaker in conversation between the first speaker and the second speaker in real time (S42).

The agent 300b of the second speaker may additionally define a style that the second speaker likes or an intention of the second speaker by learning the speech information of the second speaker transmitted in real time. Accordingly, the agent 300b of the second speaker may accurately learn the style that the second speaker likes or the intention of the second speaker using local knowledge. Details of what the agent 300b of the second speaker learns may be sufficiently described above and sufficiently inferred and thus will be omitted.

Thereafter, when the agent 300b of the second speaker acquires the style that the second speaker likes or the intended information of the second speaker through the outside or surroundings, the agent 300b of the second speaker may recommend the same through the second smart device 100b carried by the second speaker (S43).

For example, if the first speaker and the second speaker look at the first smart device 100a together and say, “This is so pretty, it's my style”, the first smart device 100a may listen to conversation therebetween. The first smart device 100a may transmit information on “This is so pretty, it's my style” and information of the second speaker to the agent 300a of the first speaker.

The agent 300a of the first speaker may authenticate based on the information of the second speaker, access the agent 300b of the second speaker, and transmit information on “This is so pretty, it's my style.”

The agent 300b of the second speaker may learn based on the transmitted “This is so pretty, it's my style.”

Thereafter, if the second speaker searches for clothes using the second smart device 100b, the agent 300b of the second speaker may provide a message of “May I recommend you a shopping mall that fits the style you liked a few days ago?” to the second speaker. When the second speaker accepts the message, the agent 300b of the second speaker may access the recommended shopping mall.

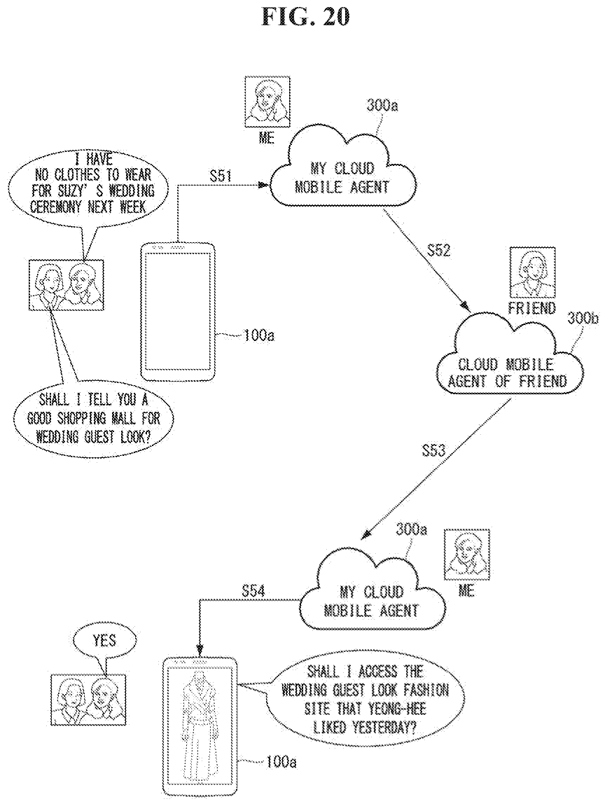

FIG. 20 is a diagram illustrating another example of a data processing method based on artificial intelligence according to an embodiment of the present disclosure.

Referring to FIG. 20, a plurality of agents according to an embodiment of the present disclosure may be evolved by constantly exchanging information between agents in a cloud environment.

The first smart device 100a may listen to conversation between the first speaker and the second speaker in real time.

The first smart device 100a may transmit information of the second speaker who is speaking to the agent 300a of the first speaker (S51).

The agent 300a of the first speaker may authenticate based on the transmitted information of the second speaker and access the agent 300b of the second speaker. For example, the agent 300a of the first speaker may authenticate based on a face of the second speaker or a voice of the second speaker.

When the second speaker knows needs information of the first speaker, the second speaker may access the agent 300b of the second speaker using the first smart device 100a and the agent 300a of the first speaker and then request needs information of the first speaker from the agent 300b of the second speaker (S52).

The agent 300b of the second speaker may transmit response information for the requested needs information of the first speaker to the agent 300a of the first speaker (S53). The agent 300a of the first speaker may be evolved by learning the response information on the transmitted needs information of the first speaker and upgrading or updating it. The agent 300a of the first speaker may perform a user request through the first smart device 100a based on the upgraded information (S54).

For example, while the first speaker and the second speaker are looking at the first smart device 100a together, if the first speaker says, “I have no clothes to wear for Suzy's wedding ceremony next week” and the second speaker says “Shall I tell you a good shopping mall for wedding guest look?”, the first smart device 100a may listen to their conversation. The first smart device 100a may transmit information on “Shall I tell you a good shopping mall for wedding guest look” and information of the second speaker to the agent 300a of the first speaker.

The agent 300a of the first speaker may authenticate based on the information of the second speaker, access the agent 300b of the second speaker, and transmit information on “Shall I tell you a good shopping mall for wedding guest look?”

The agent 300b of the second speaker may search for it based on the transmitted “Shall I tell you a good shopping mall for wedding guest look?” Thereafter, the agent 300b of the second speaker may transmit the searched information on the “wedding guest look shopping mall” to the agent 300a of the first speaker.

Upon receiving the information on the “wedding guest look shopping mall”, the agent 300a of the first speaker may upgrade intelligence so as to be evolved. The agent 300a of the first speaker may transmit the information “wedding guest look shopping mall” to the first smart device 100a and provide a message of “Shall I access the wedding guest look fashion site that Yeong-hee liked yesterday?” to the first speaker. When the first speaker accepts the message, the agent 300a of the first speaker may access the recommended shopping mall.

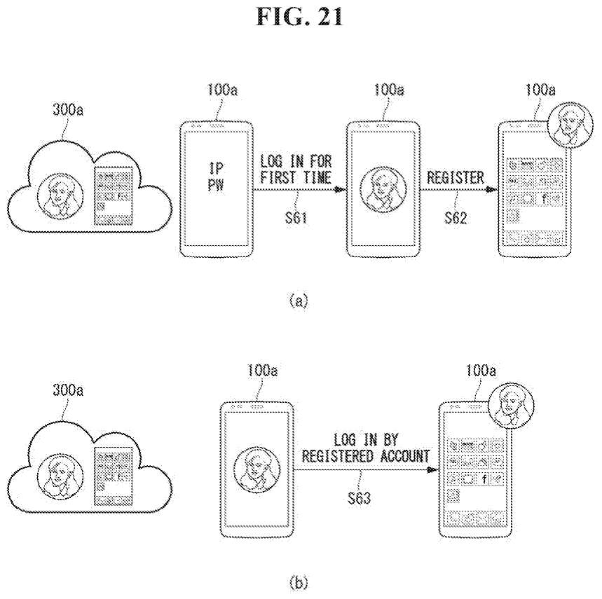

FIG. 21 is a diagram illustrating an example of accessing an agent using a smart device according to an embodiment of the present disclosure.

Referring to FIG. 21, as shown in (a), the first speaker may access the agent 300a of the first speaker using the first smart device 100a. Accordingly, an account of the first smart device 100a may be registered in the agent 300a of the first speaker.

The first smart device 100a may be defined as a personal device requiring high security. When the account of the first smart device 100a is registered in the agent 300a of the first speaker, the first smart device 100a may have a permission right. For example, the permission right may include read/write/administrator. The first speaker may access all personal information and applications in the agent 300a of the first speaker using the first smart device 100a having the registered account and change a setting (write/delete/modification is possible) of the agent 300a of the first speaker.

When the first speaker logs in for the first time to the agent 300a of the first speaker using the first smart device 100a, a high security method may be used. For example, the first speaker may access the agent 300a of the first speaker by inputting an ID/password. The ID may be a personal Google account, a phone number, or an ID created by a user. The password may be a password high security. The password may be set according to characteristics of the mobile device or smart device or a user setting. In the log-in step, in case of registering for the first time, a high security type password may be required, but once registered, log in may be performed with a relatively low security type password. For example, the high security type password may be set by combining numbers, upper and lower case letters, special characters, and a length of the password. The relatively low security type password may be set with numbers, upper and lower case letters, or a combination thereof.

As shown in (b), the first speaker may use log-in after registration as an existing screen lock/unlock method. For example, in the lock/unlock method, log in may be performed using biometric information (face, fingerprint, vein, voice, etc.), pin, and pattern.

In addition, the first speaker may register an account of the first smart device 100a in the agent 300a of the first speaker, and if the first smart device 100a is not used, the first speaker may delete the registered account. For example, the first speaker may delete the currently registered account from the first smart device 100a. In addition, when the first smart device 100a is changed, the account of a previous first smart device 100a may be deleted from a new first smart device 100a.

So far, it has been described that one first smart device 100a is connected to the agent 300a of the first speaker, but the present disclosure is not limited thereto.

A plurality of smart devices may be defined as home devices used by family members together. The home device may access an agent. Accordingly, an account of the home device may be registered in the agent.

The home device may use a high security method when logging in to the agent for the first time. For example, the home device may log in to the agent through connection with a personal main device and setting in the main device. Alternatively, a home device that does not have an input interface such as a keyboard may perform user registration and log in to the agent using a home device setting application.

In addition, the home device may perform user registration and log in by distinguishing between a device having its own SIM and a device without a SIM.

When the account of the home device is normally registered in the agent, the main device may automatically log in to the agent at a predetermined location (locally). In addition, the home device may log in to the agent using biometric information such as a user's face and voice, even without the main device.

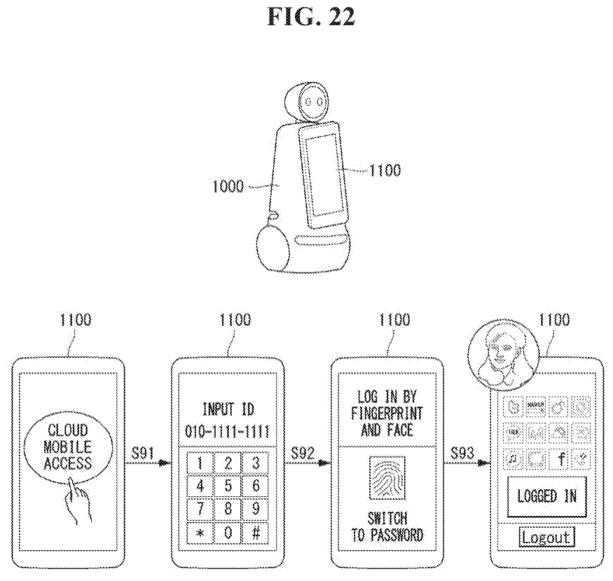

FIG. 22 is a diagram illustrating another example of accessing an agent using a smart device according to an embodiment of the present disclosure.

Referring to FIG. 22, the user may access an agent using a common smart device 1000 in a public place. The common smart device 1000 may include a display 1100.

When the user logs in to the agent using the display 1100 of the common smart device 1000 in a public place, the user may always log in in a consistent manner without a procedure such as user registration. When the user logs in to the agent using the common smart device 1000, a high security method may be used. For example, the user may access the agent by inputting an ID/password. The ID may be a personal Google account, a phone number, or any other user-created ID. As a password, a high security password may be used. The password may be set according to characteristics of a smart device or a smart device or a user setting.

In addition, the user may access the agent using the user's fingerprint or a high biometric authentication method of a complex authentication level. The agent may track the user's face and use in the case of accessing using the common smart device 1000.

In addition, when the user's face disappears or the agent is not used for a certain period of time, the agent may automatically log out, thereby blocking access between the agent and the common smart device 1000.

In addition, the agent may request warning and another authentication of the user if the user's usage pattern is different. For example, the usage pattern may be touch or key input.

The agent may delete all user information from the common smart device 1000 after the common smart device 1000 is logged out.

The agent of the first speaker of the present disclosure described so far may recognize the second speaker in order to connect with the agent of the second speaker in the cloud environment.

The agent of the first speaker may recognize the second speaker using explicit recognition for recognizing through explicit face tagging from a name, a phone number list, or a photograph stored in the agent of the first speaker of the first smart device or using implicit recognition for recognizing by voice through a call conversation.

In addition, the agent of the first speaker of the present disclosure may connect a person or friend around the first speaker in various ways. For example, the agent of the first speaker may be connected to the agent of the second speaker by explicitly requesting the first speaker from the agent of the second speaker or may be automatically connected to the agent of the second speaker by recognizing closeness between the first speaker and the second speaker.

After the agent of the first speaker and the agent of the second speaker are connected to each other, various information (e.g., photos) may be exchanged or cooperated within a permitted range.

When the first speaker is a friend of the second speaker, the first speaker may access the agent of the second speaker with low security through the agent of the first speaker.

In addition, both the agent of the first speaker and the agent of the second speaker may operate so that commands of the first speaker and the second speaker may be executed by the respective first smart device and the second smart device. Alternatively, only one of the agent of the first speaker or the agent of the second speaker operates and the first and second smart devices on the cloud may communicate with each other to execute their own commands.

In addition, the agent of the first speaker may release the connection at the request of the first speaker explicitly to the agent of the second speaker. Alternatively, the agent of the first speaker may be automatically released when there is no communication with the agent of the second speaker for a predetermined time.

Effects of the data processing method based on artificial intelligence according to an embodiment of the present disclosure will be described as follows.

In the present disclosure, in the smart device of a cloud environment, agents in the cloud may cooperate with each other while sharing information between multiple agents according to a grant of a user permission.

In the present disclosure, duplicate installation of an application may be prevented by cooperation, while sharing information between multiple agents.

The effects which may be acquired by the present invention are not limited to the aforementioned effects, and other technical effects not described above may be evidently understood by a person having ordinary skill in the art to which the present invention pertains from the following description.

The above-described present disclosure can be implemented as a computer-readable code on a medium on which a program is recorded. The computer readable medium includes all kinds of recording devices in which data that can be read by a computer system is stored. Examples of the computer readable medium may include a hard disk drive (HDD), a solid state disk (SSD), a silicon disk drive (SDD), a ROM, a RAM, a CD-ROM, a magnetic tape, a floppy disk, an optical data storage device, and the like, or be implemented in the form of a carrier wave (e.g., transmission over the internet). Accordingly, the above detailed description should not be construed in all aspects as limiting, and be considered illustrative. The scope of the present disclosure should be determined by rational interpretation of the appended claims, and all changes within the equivalent range of the present disclosure are included in the scope of the present disclosure.

What is claimed is:

1. A data processing method based on artificial intelligence, the data processing method comprising:
accessing an agent of a first speaker in a cloud;
collecting conversation, while listening to a conversation between the first speaker and a second speaker using a first smart device connected to the agent of the first speaker;
accessing an agent of the second speaker in the cloud through the agent of the first speaker;
determining, if a preset wake-up word in the conversation is sensed, whether an application is executed in the first smart device based on the wake-up word;
cooperating between the connected agent of the first speaker and the connected agent of the second speaker, while sharing information, if the application is not executed; and
executing the application in the first smart device according to a result of the cooperation.

2. The data processing method of claim 1, wherein,
in the accessing to the agent of the first speaker in the cloud, the first smart device and the agent of the first speaker are connected to each other if the first speaker logs in through the first smart device.

3. The data processing method of claim 1, wherein
the accessing to the agent of the second speaker comprises:
determining the second speaker based on a voice of the second speaker in the conversation; and
connecting the agent of the first speaker to the agent of the second speaker if the second speaker is determined.

4. The data processing method of claim 3, wherein
the determining of the second speaker comprises:
extracting feature values from sensing information acquired through the voice of the second speaker; and
inputting the feature values to an artificial neural network (ANN) trained to distinguish the second speaker through the feature values and determining the second speaker from an output of the ANN,
wherein the feature values are values for distinguishing the second speaker.

5. The data processing method of claim 4, wherein
the voice of the second speaker includes speaker identification, acoustic event detection, gender and age detection, voice activity detection, and emotion classification.

6. The data processing method of claim 1, wherein
the agent of the second speaker determines normal connection upon receiving information on the second speaker from the agent of the first speaker.

7. The data processing method of claim 6, wherein
the agent of the second speaker transmits information on the normal connection to a second smart device connected to the agent of the second speaker.

8. The data processing method of claim 3, further comprising:
receiving downlink control information (DCI) used for scheduling transmission of the voice of the second speaker,
wherein the voice of the second speaker is transmitted to the network based on the DCI.

9. The data processing method of claim 8, further comprising:
performing an initial access procedure with the network based on a synchronization signal block (SSB),
wherein the voice of the second speaker is transmitted to the network via a physical uplink shared channel (PUSCH), and
wherein the SSB and a demodulation reference signal (DM-RS) of the PUSCH are quasi-co-located (QCL) for a QCL type D.

10. The data processing method of claim 8, further comprising:
controlling a transceiver to transmit the voice of the second speaker to an AI processor included in the network; and
controlling the transceiver to receive AI-processed information from the AI processor,
wherein the AI-processed information is information for determining the second speaker.
